(19) United States
(12) Patent Application Publication
(10) Pub. No.: US 2014/0166844 A1
(43) Pub. Date: Jun. 19, 2014

(54) Frequency Altering Brace For An Electric Motor

(71) Applicant: NIDEC MOTOR CORPORATION, St. Louis, MO (US)

(72) Inventors: David M. Lyle, Glencoe, MO (US); Timothy J. Druhe, Granite City, IL (US)

(73) Assignee: NIDEC MOTOR CORPORATION, St. Louis, MO (US)

(21) Appl. No.: 13/720,450

(22) Filed: Dec. 19, 2012

(51) Int. Cl. F16F 15/12

(52) U.S. Cl. CPC F16F 15/1207
USPC 248/560

(57) ABSTRACT

A support brace for a motor enables altering the stiffness and reed critical frequency of a motor system without removal of the motor from a motor stand or support structure. The support brace includes a first flange configured to mount to an electrical motor housing, and a second flange configured to mount to a supporting fixture. The flanges are connected by a member that extends between the flanges and is configured to increase a stiffness of the electrical motor to modify a resonance frequency of the electrical motor.

### TECHNICAL FIELD

This disclosure relates generally to electric motors, and, in particular, to support braces for electric motors.

### BACKGROUND

Electric motors are used in various household, office, automotive, and industrial applications. A typical electric motor includes a rotor surrounded by an electromagnet, called a stator. When varying electrical energy is applied to the stator, a magnetic field is generated that produces a torque that spins the rotor. The rotor includes an output shaft that connects to an output device, such as a pump, fan, belt, or gear, to operate the device with the rotational output of the motor. A vertically mounted electric motor is one in which the output shaft is oriented vertically to enable the output shaft to be coupled to an output device positioned above or below the motor. Vertical motors rest on a stand, which is configured to provide a stable platform for the motor and output device. Horizontally oriented motors, on the other hand, are mounted such that the output shaft extends from the motor housing horizontally and the output shaft couples to an output device located next to the horizontal motor.

During operation of an electric motor, the rotating components of the motor generate vibrations that resonate at various frequencies. A motor and housing system has a resonance frequency (also known as a reed-critical frequency or “RCF”), which is a function of the mass, distribution of the mass, and base geometry of the motor and housing system. If the frequency of the vibrations in the system is close to or the same as the RCF of the motor system, the vibrations are amplified through the motor system, generating loud noises and potentially resulting in mechanical issues with the motor.

The frequency of the vibrations and the RCF can be calculated in a motor based on the operating conditions of the motor and the geometry of the system. Thus, a motor base is typically designed such that the RCF is not near the vibration frequencies. However, in some instances, issues develop after installation of a vertical motor that arise from changed operating conditions or erroneous calculations. One solution to RCF vibration issues involves replacing the motor with a motor of a different size, which produces different vibration frequencies and has a different RCF. Another solution is to replace the motor stand, which also alters the RCF of the motor system. However, both solutions require removing the motor from the stand. Vertical motors in industrial applications are often very large and heavy, and heavy equipment is required to remove the motor from the stand. Thus, replacing the motor or stand can be very expensive. Consequently, an improved solution to RCF vibration issues is desirable.

### SUMMARY

In one embodiment a brace dampens resonant vibration of an electrical motor mounted to a stand. The brace comprises a first flange configured to mount to an electrical motor housing, a second flange configured to mount to a supporting fixture of the electrical motor, and a member extending between the first flange and the second flange. The member is configured to increase a stiffness of the electrical motor and supporting fixture to modify a resonance frequency of the electrical motor.

In another embodiment a method has been developed to dampen resonant vibration of an electrical motor. The method includes mounting a first flange of a brace to an electrical motor housing and mounting a second flange of the brace to a supporting fixture of the electrical motor. The second flange is connected to the first flange by a member extending between the first and second flanges, and the member is configured to increase a stiffness of the electrical motor and supporting fixture to modify a resonance frequency of the electrical motor.

In yet another embodiment, a system enables dampening of resonant vibration of an electrical motor. The system comprises a plurality of braces, each of which includes a first flange configured to mount to an electrical motor housing, a second flange configured to mount to a supporting fixture of the electrical motor, and a member extending between the first flange and the second flange. The member of each brace is configured to increase a stiffness of the electrical motor and supporting fixture to modify a resonance frequency of the electrical motor. Each brace in the plurality of braces is mounted to the electrical motor housing and the supporting fixture at a position that is different than a position at which the other braces of the plurality of braces are mounted to enable the members of the plurality of braces to stiffen the electrical motor around a perimeter of the electrical motor to modify the resonance frequency of the electrical motor.

### BRIEF DESCRIPTION OF THE DRAWINGS

FIG. 1 is a side perspective view of a motor system having braces.

FIG. 2 is a schematic top view of the brace of FIG. 1.

FIG. 3 is a rear perspective view of the brace of FIG. 1.

FIG. 4 is a side perspective view of the brace of FIG. 1.

FIG. 5 is a side perspective view of an electrical motor housing including two embodiments of a brace.

### DETAILED DESCRIPTION

As used herein, the term “supporting fixture” refers to a structure that supports at least a portion of the electrical motor. The supporting fixture can be a mounting plate positioned on or beneath a motor housing, a portion of the motor housing, a motor frame, a motor stand, or a foundation or other structure on which the motor is installed.

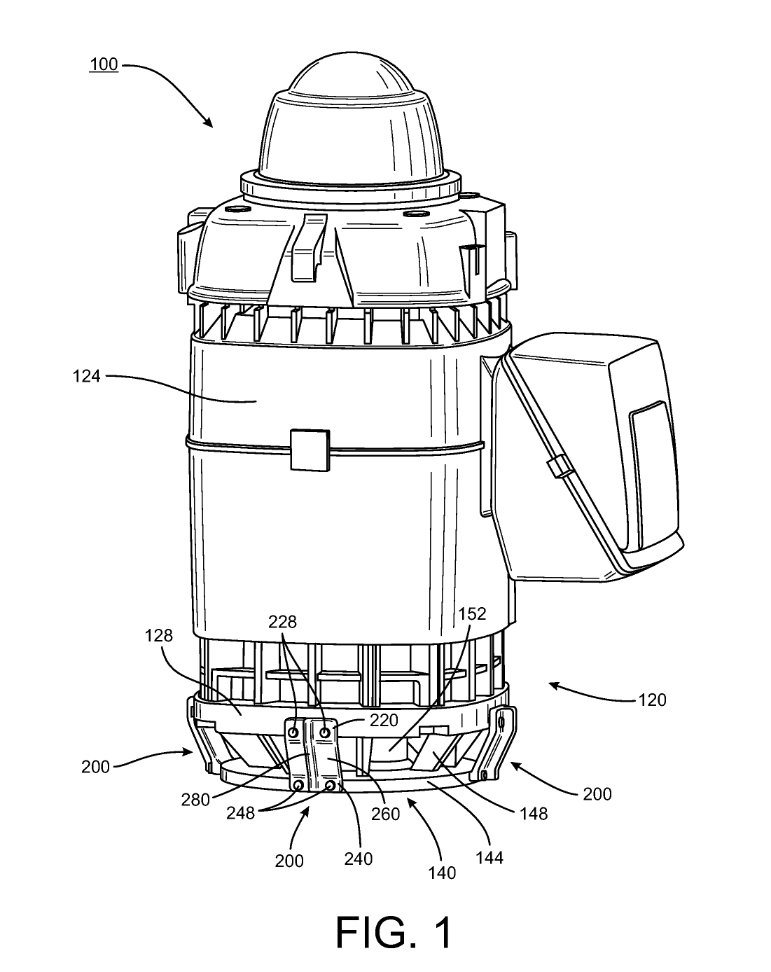

FIG. 1 depicts a vertical motor system 100. The vertical motor system 100 comprises a motor housing 120, a motor stand 140, and a plurality of braces 200. The motor housing 120 includes a motor cover 124 and a housing base 128. An electric motor (not shown) is positioned inside the motor cover 124, mounted to the housing base 128. In the embodiment of FIG. 1, the motor cover 124 and housing base 128 are sealed, and are sealingly connected to one another, to prevent debris from interfering with operation of the motor and to enable installation of the motor system 100 in hostile or outdoor environments. In other embodiments, the motor cover and base are not sealed.

The motor stand 140 includes a mounting plate 144, a plurality of fixed supports 148, and an output shaft casing 152. The motor stand 140 is configured to enable the motor system 100 to be mounted on an output device, for example a pump, to which the motor delivers rotational motion. In other embodiments, the motor stand can be configured to mount the output device to the ground or a foundation. The output shaft casing 152 surrounds an output shaft (not shown) of the motor in the region between the motor housing 120 and the output device. A plurality of fixed supports 148 positioned around a circumference of the motor system 100 extend from the mounting plate 144 to the housing base 128 to connect the mounting plate 144 and housing base 128 and provide structural support for the housing base 128.

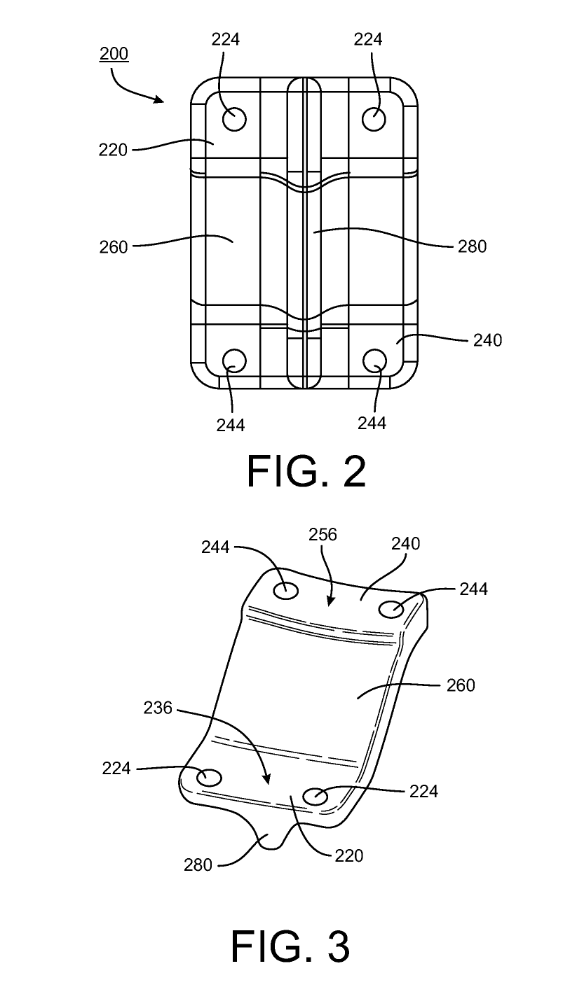

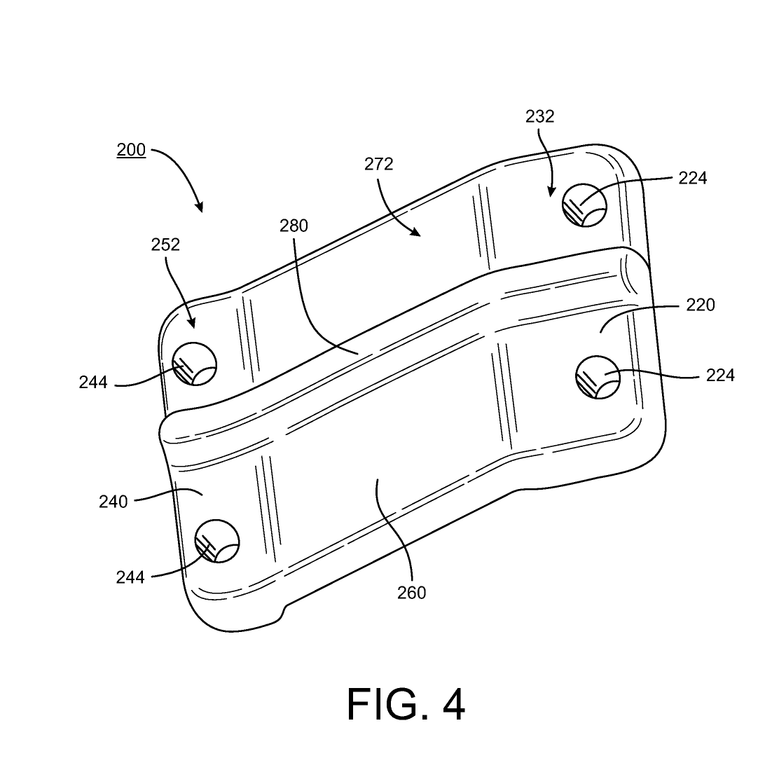

Referring to FIG. 2-4 with continuing reference to FIG. 1, the braces 200 include a first flange 220, a second flange 240, a connecting member 260, and a rib 280. The connecting member 260 extends between the first 220 and second 240 flanges to connect the flanges 220 and 240. The rib 280 extends from the outer surfaces 232, 252, and 272 of the first flange 220, second flange 240, and connecting member 260, respectively, substantially perpendicular to the surfaces 232, 252, and 272. The rib 280 is configured to provide structural support between the first 220 and second 240 flanges to supplement the stiffness of the brace 200.

In the illustrated embodiment, each of the first 220 and second 240 flanges include two apertures 224 and 244, respectively. Apertures 224 are configured to enable a securing member 228, for example a bolt, to pass through the aperture 224 and into a threaded hole formed in the housing base 128 to affix the first flange 220 to the housing base 128. Likewise, apertures 244 are configured to enable a securing member 248 to pass through the aperture 244 and into a threaded hole formed in the mounting plate 144 to affix the second flange 240 to the mounting plate 144. In other embodiments, more or fewer apertures and securing members can be used to affix the brace to the housing base and mounting plate. In yet another embodiment, the brace does not include apertures, but is affixed to the housing and mounting plate by other methods, such as welding, for example.

As illustrated in FIG. 3, an interior surface 236 of the first flange 220 is curved. The curvature of the interior surface 236 is configured to match a curvature of the housing base 128 to enable the first flange 220 to mount securely to the housing base 128 Likewise, the interior surface 256 of the second flange 240 is curved to match a curvature of the mounting plate 144 to enable the second flange 240 to mount securely to the mounting plate 144.

When a vibration issue is discovered in a vertically mounted motor, such as motor system 100, the braces 200 are installed between the housing base 128 and the mounting plate 144 to alter the stiffness, and thus the RCF, of the motor system 100. Each brace 200 of the illustrated embodiment is installed by placing the brace 200 against the motor housing 120 and mounting plate 144. Holes are drilled into the motor housing 120 and mounting plate 144, using the apertures 224 and 244 in the brace 200 as guide holes. The holes in the motor housing 120 and mounting plate 144 are tapped to enable securing members 248 to be inserted through the apertures 224 and 244 into the holes in the motor housing 120 and mounting plate 144, respectively, to secure the brace 200 to the motor housing 120 and mounting plate 144. As noted above, any suitable number of securing members can be used to affix the brace to the housing base and mounting plate. In other embodiments, the brace is affixed to the housing and mounting plate by other methods, such as welding, for example.

Providing the braces 200 on the motor system 100 serves to stiffen the bending moment of the motor stand 140 and the lower part of the motor housing 120. In response to the stiffened bending moment, the fixed supports 148 of the motor stand 140 bend less with the vibrations, altering the RCF of the system. The critical frequency is altered by a predetermined amount to ensure that the RCF of the system is outside the range of vibration frequencies, avoiding amplification of the system vibrations. Although FIG. 1 illustrates a system having four braces spaced substantially equally around the motor housing 120 and motor stand 140, any suitable number of braces can be installed on a motor in other embodiments at any suitable spacing. Mounting additional braces to the motor system 100 increases the stiffness of the motor system 100, further altering the RCF.

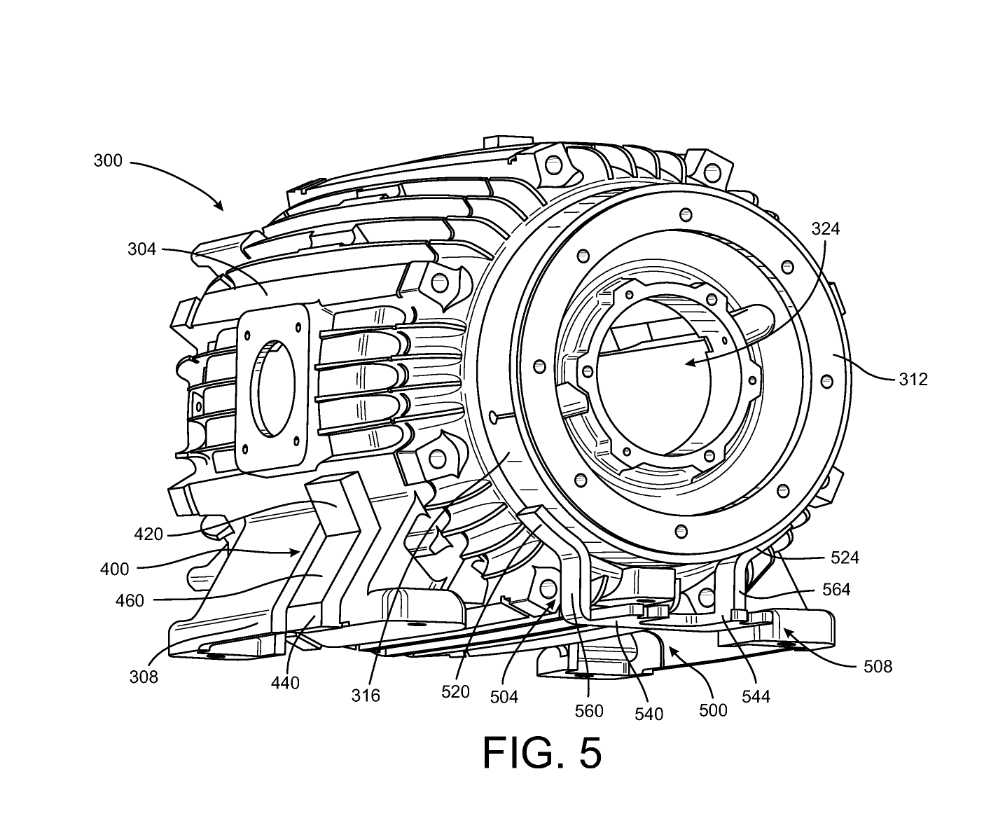

FIG. 5 depicts an electrical motor housing 300 configured to be mounted in a horizontal configuration, with no electrical motor shown in the housing for clarity. The electrical motor housing 300 includes a housing motor cover 304, two housing supports 308, and an end cap 312. The housing motor cover has a housing ring at a first end 316 that surrounds the end cap 312. The housing motor cover 304 and end cap 312 define a chamber 324 that is configured to accommodate an electrical motor (not shown) having an output shaft that extends out of the housing 300 through the end cap 312. The housing supports 308 are configured to secure the motor housing 300 and associated motor to a foundation, motor stand, or other mounting structure (not shown).

FIG. 5 depicts a first brace 400 and a second brace 500, each of which is configured to be installed on a horizontally oriented electrical motor housing, such as the housing 300 shown in FIG. 5. Although the embodiment of FIG. 5 illustrates both braces 400 and 500 as being installed on the motor housing, the reader should appreciate that the system can be operated with only one of the illustrated braces, or that the system can include more than one of either brace or more than one of both braces 400 and 500. The first brace 400 includes a first flange 420, a second flange 440, and a connecting member 460. The connecting member 460 is fixedly attached to both the first flange 420 and second flange 440, and extends between the first flange 420 and the second flange 440. The first flange 420 is configured to be affixed to an exterior of the housing motor cover 304, while the second flange 440 is configured to be affixed to one of the housing supports 308. In the illustrated embodiment, the connecting member 460 is positioned against the housing support 308. In some embodiments, however, the connecting member can be affixed to the housing support, while in other embodiments the connecting member can be positioned such that there is a gap between the connecting member and the housing support.

The second brace 500 includes a first brace portion 504 and a second brace portion 508. The first brace portion 504 includes a first flange 520, a second flange 540, and a first connecting member 560, while the second brace portion includes a third flange 524, a fourth flange 544, and a second connecting member 564. The first flange 520 is configured to be affixed to the housing ring 316, while the second flange 540 is affixed to a supporting structure (not shown), such as a foundation, motor stand, or other structure on which the motor is mounted. Likewise, the third flange 524 is affixed to the housing ring 316, while the fourth flange 544 is affixed to the supporting structure. The second flange 540 and fourth flange 544 are connected, such that the first brace portion 504 and the second brace portion 508 form a single brace 500.

The first brace 400 and the second brace 500 operate in substantially the same manner as the brace 200 described above with reference to the vertically mounted motor. Providing the braces 400 or 500 on the motor housing 300 serves to stiffen the bending moment of the motor and motor housing 300. In response to the stiffened bending moment, the housing moves less with the vibrations generated by the motor, altering the RCF of the system. The critical frequency is altered by a predetermined amount to ensure that the RCF of the system is outside the range of vibration frequencies, avoiding amplification of the system vibrations.

The first brace 400 and the second brace 500 can be affixed to the motor housing 300 and/or the support structure (not shown) in any suitable manner. For example, the flanges of the braces 400 or 500 can be attached by inserting a threaded member through an aperture in the flange, or the flanges can be welded to the housing or support structure. Furthermore, the reader should appreciate that the support braces can be suitably mounted to any number of different structures on the motor housing or the motor support structure to alter the RCF of the motor system, as long as the support brace alters the stiffness of the motor system and alters the RCF of the motor system to reduce vibrations in the system.

It will be appreciated that variations of the above-disclosed apparatus and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. A brace for dampening resonant vibration of an electrical motor mounted to a stand comprising:
a first flange configured to mount to an electrical motor housing;
a second flange configured to mount to a supporting fixture of the electrical motor; and
a member extending between the first flange and the second flange, the member being configured to increase a stiffness of the electrical motor and supporting fixture to modify a resonance frequency of the electrical motor.

2. The brace of claim 1, wherein the second flange is further configured to mount to a mounting plate that enables the electrical motor housing to be mounted to a stand that supports the electrical motor.

3. The brace of claim 2, wherein the brace is further configured to be installed on an electrical motor that is mounted to a vertical stand, which supports the electrical motor in a vertical orientation.

4. The brace of claim 1, wherein the second flange is further configured to mount to a structure on which the electrical motor is installed in a horizontal orientation.

5. The brace of claim 3 wherein the first flange and the second flange are curved to complement a portion of a circumference of the electrical motor housing and a portion of the mounting plate, respectively.

6. The brace of claim 1 wherein the first flange is laterally offset from the second flange.

7. The brace of claim 1 further comprising:
at least one rib extending from the member in a plane that is perpendicular to a plane in which the member extends between the first flange and the second flange.

8. The brace of claim 6 wherein the at least one rib extends from the first flange and from the second flange in the plane that is perpendicular to a surface of the first flange and a surface of the second flange, respectively.

9. The brace of claim 1 further comprising:
at least one aperture in the first flange to enable the first flange to be mounted to the electrical motor housing by passing a securing member through the at least one aperture into a portion of the electrical motor housing; and
at least one aperture in the second flange to enable the second flange to be mounted to the supporting fixture by passing a securing member through the at least one aperture into a portion of the supporting fixture.

10. A method for dampening resonant vibration of an electrical motor comprising:
mounting a first flange of a brace to an electrical motor housing; and
mounting a second flange of the brace to a supporting fixture of the electrical motor, the second flange being connected to the first flange by a member extending between the first and second flanges, the member being configured to increase a stiffness of the electrical motor and supporting fixture to modify a resonance frequency of the electrical motor.

11. The method of claim 10, the mounting of the second flange further comprising:
mounting the second flange to a mounting plate that enables the electrical motor housing to be mounted to a vertical stand, which supports the electrical motor in a vertical orientation.

12. The method of claim 10, the mounting of the second flange further comprising:
mounting the second flange to a structure on which the electrical motor is installed in a horizontal orientation.

13. The method of claim 10, the mounting of the first and second flanges further comprising:
passing at least one securing member through at least one aperture in the first flange into a portion of the electrical motor housing to mount the first flange to the electrical motor housing; and
passing at least one securing member through at least one aperture in the second flange into a portion of the supporting fixture to mount the second flange to the support fixture.

14. The method of claim 11 further comprising:
mounting the first and second flanges while the electrical motor is mounted to the vertical stand.

15. The method of claim 10 further comprising:
mounting a first flange of a second brace to the electrical motor housing;
mounting a second flange of the second brace to a supporting fixture of the electrical motor, the second flange of the second brace being connected to the first flange of the second brace by a member extending between the first and second flanges of the second brace;
mounting a first flange of a third brace to the electrical motor housing;
mounting a second flange of the third brace to a supporting fixture of the electrical motor, the second flange of the third brace being connected to the first flange of the third brace by a member extending between the first and second flanges of the third brace;
mounting a first flange of a third brace to the electrical motor housing;
mounting a second flange of the fourth brace to a supporting fixture of the electrical motor, the second flange of the fourth brace being connected to the first flange of the fourth brace by a member extending between the first and second flanges of the fourth brace; and
each of the braces being mounted to the electrical motor housing and the supporting fixture at a position that is different from a position at which the other braces are mounted to the electrical motor housing and the supporting fixture to enable the members to stiffen the electrical motor around a perimeter of the electrical motor to modify the resonance frequency of the electrical motor.

16. A system for dampening resonant vibration of an electrical motor comprising:
a plurality of braces, each brace of the plurality of braces including:
a first flange configured to mount to an electrical motor housing;
a second flange configured to mount to a supporting fixture of the electrical motor; and
a member extending between the first flange and the second flange, the member being configured to increase a stiffness of the electrical motor and supporting fixture to modify a resonance frequency of the electrical motor; and
each brace in the plurality of braces is mounted to the electrical motor housing and the supporting fixture at a position that is different than a position at which the other braces of the plurality of braces are mounted to enable the members of the plurality of braces to stiffen the electrical motor around a perimeter of the electrical motor to modify the resonance frequency of the electrical motor.

17. The system of claim 16, wherein the second flange of each of the plurality of braces is configured to mount to a mounting plate that enables the electrical motor housing to be mounted to a stand that supports the electrical motor.

18. The system of claim 17, wherein the braces are configured to be installed on an electrical motor that is configured to be mounted to a vertical stand, which supports the electrical motor in a vertical orientation.

19. The system of claim 16, wherein the second flange of each of the plurality of braces is configured to mount to a structure on which the electrical motor is installed in a horizontal orientation.

20. The system of claim 18 wherein the first flange and the second flange of each brace are curved to complement a portion of a circumference of the electrical motor housing and a portion of the mounting plate, respectively.

21. The system of claim 16 wherein the first flange of each brace is laterally offset from the second flange of the corresponding brace.

22. The system of claim 16, each brace of the plurality of braces further comprising:
at least one rib extending from the member in a plane that is perpendicular to a plane in which the member extends between the first flange and the second flange.

23. The system of claim 22 wherein the at least one rib of each brace extends from the first flange and from the second flange in a plane that is perpendicular to a surface of the first flange and a surface of the second flange, respectively.

24. The system of claim 16, each brace further comprising:
at least one aperture in the first flange to enable the first flange to be mounted to the electrical motor housing by passing a securing member through the at least one aperture into the a portion of the electrical motor housing; and
at least one aperture in the second flange to enable the second flange to be mounted to the supporting fixture by passing a securing member through the at least one aperture into a portion of the supporting fixture.
